(19) United States
(12) Patent Application Publication
(10) Pub. No.: US 2011/0024697 A1
(43) Pub. Date: Feb. 3, 2011

(54) Methods of Producing Carbon Nanotubes and Applications of Same

(75) Inventors: Alexandru S. Biris, Little Rock, AR (US); Yang Xu, Little Rock, AR (US); Dervishi Enkeleda, Little Rock, AR (US); Li Zhongrui, Little Rock, AR (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: BOARD OF TRUSTEES OF THE UNIVERSITY OF ARKANSAS, Little Rock, AR (US)

(21) Appl. No.: 12/752,513

(22) Filed: Apr. 1, 2010

Related U.S. Application Data
(63) Continuation-in-part of application No. 12/371,851, filed on Feb. 16, 2009.
Application No. 12/371,851 is a continuation-in-part of application No. 12/217,978, filed on Jul. 10, 2008.
Application No. 12/217,978 is a division of application No. 11/228,023, filed on Sep. 15, 2005, now Pat. No. 7,473,873.
Application No. 11/228,023 is a continuation-in-part of application No. 11/131,912, filed on May 18, 2005.
(60) Provisional application No. 60/571,999, filed on May 18, 2004.
(60) Provisional application No. 60/611,018, filed on Sep. 17, 2004.

(51) Int. Cl. H01B 1/24; D01F 9/12; B05D 5/12; B82Y 99/00; B82Y 40/00; B82Y 30/00

(52) U.S. Cl. 252/511; 423/447.1; 423/447.2; 427/122; 977/742; 977/843; 977/932

(57) ABSTRACT

The present invention in one aspect relates to a method for producing carbon nanotubes. In one embodiment, the method includes the steps of forming a substrate, depositing a loading amount of catalyst including iron and cobalt nanoparticles on the surfaces of the substrate, and heating the catalyst deposited on the substrate in a radio frequency reactor having a flow of a methane carbon source at a predetermined temperature so as to cause the growth of carbon nanotubes on the substrate.

### CROSS-REFERENCE TO RELATED PATENT APPLICATION

This application claims priority to and the benefit of, pursuant to 35 U.S.C. §119(e), U.S. provisional patent application Ser. No. 61/211,805, filed Apr. 3, 2009, entitled “Carbon Nanotubes Growth on Oxides Pellet and Their Applications,” by Yang Xu et al., the disclosure of which is incorporated herein in their entirety by reference.

This application is also a continuation-in-part application of U.S. patent application Ser. No. 12/371,851, filed Feb. 16, 2009, entitled “Methods of Making Horizontally Oriented Long Carbon Nanotubes and Applications of Same”, by Alexandru S. Biris et al., which itself is a continuation application of U.S. patent application Ser. No. 12/217,978, filed Jul. 10, 2008, entitled “Apparatus and Methods for Synthesis of Large Size Batches of Carbon Nanostructures,” by Alexandru S. Biris et al., which itself is a divisional application of U.S. patent application Ser. No. 11/228,023, filed Sep. 15, 2005, entitled “Apparatus and Methods for Synthesis of Large Size Batches of Carbon Nanostructures,” by Alexandru S. Biris et al. and which status is issued as U.S. Pat. No. 7,473,873, which itself is a continuation-in-part application of U.S. patent application Ser. No. 11/131,912, filed May 18, 2005, entitled “Apparatus and Methods of Making Nanostructures by Inductive Heating,” by Alexandru R. Biris et al., which itself claims priority to and the benefit of, pursuant to 35 U.S.C. §119(e), of both U.S. provisional patent application Ser. No. 60/571,999, filed May 18, 2004, entitled “Apparatus and Methods of High Throughput Generation of Nanostructures by Inductive Heating And Improvements Increasing Productivity While Maintaining Quality and Purity,” by Alexandru R. Biris et al., and U.S. provisional patent application Ser. No. 60/611,018, filed Sep. 17, 2004, entitled “Apparatus And Methods for Synthesis of Large Size Batches of Carbon Nanostructures,” by Alexandru S. Biris et al., the disclosures of all which are incorporated herein by reference in their entireties, respectively.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention is generally related to the field of production of nanostructures, and, more particularly, is related to a radio frequency chemical vapor depositon (RF-CVD) process for the growth of carbon nanotubes (CNTs) on a substrate of pellet oxides.

### BACKGROUND OF THE INVENTION

Fullerenes and carbon nanotubes were discovered in 1985 by Smalley and in 1991 by Sumio lijima, respectively. The most common methods specifically for the preparation of carbon single-walled nanotubes (SWNTs) include laser evaporation, electric arc discharge, and chemical vapor deposition (CVD) methods.

Some progresses have been made in controlling nanotube orientation when growing SWNTs with the catalytic chemical vapor deposition (CCVD). For example, electric fields have been used to grow and align suspended SWNTs and SWNTs on flat surfaces. Additionally, electric fields based on the CCVD of ethylene have been used for vectorial growth of SWNT arrays on a surface. However, the introduction of a strong electric field during the growth of nanotubes is not an easy task. Furthermore, organizing SWNTs arrays into multidimensional crossed-network structures in a controllable manner has not been demonstrated.

Nanotubes, particularly SWNTs, are useful systems for investigating fundamental electronic properties and for use as building blocks for molecular electronics because of their small size, unique low-dimensional structure, and electronic properties. Some nanoelectronic devices based on individual SWNTs include quantum wires, field-effect transistors, logic gates, field emitters, diodes, and inverters. For applications in nanoelectronics, the capability to control the locations and orientations of nanotubes is very important for large-scale fabrications of devices. SWNTs can also be utilized for producing high strength composite materials. For application to high strength composite materials, lengthy nanotubes can improve the load transfer between an individual nanotube and a nanotube matrix.

Currently, nanodevices made of individual SWNTs can be prepared by either depositing a suspension of purified bulk nanotube samples on a substrate or by directly growing individual nanotubes on a substrate with the CVD. The first approach suffers from the presence of more defects and altered electrical properties of the nanotubes due to the use of highly oxidative chemicals and the sonification process during purification and suspension processes. The CVD method includes advantages in terms of low temperature, large-scale production and controllability. Much effort has been made to successfully grow SWNTs on surfaces by using isolated catalytic nanoparticles or identical clusters.

In view of the known methods for fabricating nanotubes, it is desirable to have an improved method and system for fabricating nanotubes. Additionally, it is desirable to provide fabrication methods having improved control of the location and orientation of SWNTs produced on substrates. It is also desirable to provide an improved method and system for producing organized SWNT arrays in large-scale, carbon nanotube-based nanodevice or nanocomposite.

Therefore, a heretofore unaddressed need exists in the art to address the aforementioned deficiencies and inadequacies.

### SUMMARY OF THE INVENTION

In one aspect, the present invention relates to a radio frequency chemical vapor deposition (RF-CVD) process for the growth of SWNTs on a substrate of pellet oxides, such as MgO, SiO₂, Al₂O₃ and the like. According to the invention, a methane carbon source is decomposed in the presence of iron-cobalt alloy catalyst to grow SWNTs at different temperatures from about 500° C. to about 2500° C. Different amounts of iron-cobalt ethanol solution are dropped on the surface of MgO pellet making a uniform layer of catalyst. High quality of SWNTs is synthesized on the pellet surface. Little amount of catalyst and cheaper support materials are needed in the invention which lowers the production expenses in the future large scale synthesis. By the CCVD method, the MgO surface property is dramatically changed from an insulator to a low resistance n-type semiconducting material after the CNTs growth process. Also the invention is comprised of multiple materials such as polymers, ceramics, carbon nanostructures and other nanomaterials, arranged in any structure and form that include disks, cylinders, etc. Such complex composites could be used for fuel cell applications, energy conversion, etc.

In another aspect, the present invention relates to a method for producing carbon nanotubes. In one embodiment, the method comprises the steps of forming a substrate, depositing a loading amount of catalyst including iron and cobalt nanoparticles on the surfaces of the substrate, and heating the catalyst deposited on the substrate in a radio frequency reactor having a flow of a methane carbon source at a predetermined temperature so as to cause the growth of carbon nanotubes on the substrate.

In one embodiment, the substrate is formed by filling an amount of calcined MgO powders in a desired mold, and applying a predetermined pressure on the mold to consolidate the calcined MgO powders so as to form the substrate.

The loading amount of catalyst is in a range of about 0.01% to about 20% by weight. The predetermined temperature is in a range of about 500° C.-2500° C.

In yet another aspect, the present invention relates to a method for producing carbon nanotubes. In one embodiment, the method includes the steps of providing a substrate, depositing a catalyst on the substrate, placing the substrate with the deposited catalyst in a reactor set in a furnace through which a flow of a carbon gas is passed into the reactor, and heating the catalyst to a predetermined temperature such that carbon nanotubes grow from the reaction of the catalyst with the carbon gas.

In one embodiment, the reactor has a quartz tube, and wherein the furnace is a radio frequency furnace or oven.

The catalyst comprises one or more metals selected from group VIII of the periodic table of the elements. In one embodiment, the catalyst comprises a single metallic catalyst or a multi metallic catalyst. The multi metallic catalyst comprises a bimetallic catalyst comprising two metals, where the ratio of the two metals is in a range from about 15:1 to about 1:1, and preferably about 2:1 to 1:1. In one embodiment, the bimetallic catalyst is formed in situ through decomposition of a precursor compound including ferric nitrate and cobalt nitrate.

In one embodiment, the amount of the deposited catalyst on the substrate is in a range from about 0.01% to about 20% by weight. The predetermined temperature is in a range of about 500° C.-2500° C.

In one embodiment, the carbon gas comprises aliphatic hydrocarbons, a saturated gas, and an unsaturated gas including methane, ethane, propane, butane, hexane, ethylene, acetylene, CO, CO₂, methanol, ethanol, toluene, benzene and naphthalene and the mixtures of them. In another embodiment, the carbon gas is mixed with a diluted gas including as helium, argon, nitrogen or hydrogen.

In one embodiment, the substrate is formed with oxide powders including MgO, SiO₂, or AI₂O.

In one embodiment, the carbon nanotubes comprise single walled carbon nanotubes having a diameter of from about 0.1 nm to 10 nm, and/or multi-walled carbon nanotubes having an external diameter of from about 1 nm to about 100 nm.

In a further aspect, the present invention relates to a method for producing carbon nanotubes. In one embodiment, the method includes the step of heating a metallic catalyst selected from group VIII of the periodic table of the elements with a carbon source in a radio frequency (RF) reactor to a predetermined temperature so as to grow carbon nanotubes from the reaction of metallic catalyst with the carbon source.

The metallic catalyst is attached on a substrate. The carbon nanotubes are grown on the substrate by the catalytic chemical vapor deposition of hydrocarbon as the carbon source on the metallic catalyst attached on the substrate.

The predetermined temperature is in a range of about 500° C.-2500° C.

In yet a further aspect, the present invention relates to carbon nanotubes produced according to the methods disclosed above.

In one aspect, the present invention relates to a method for synthesizing a composite having the carbon nanotubes disclosed above, comprising the step of depositing one or more materials onto/into the composite. The one or more materials comprise at least one of polymeric materials, metal nanoparticles, metal oxide nanoparticles, metals, ceramics, and biological systems.

In one embodiment, the depositing is performed with an electrodeposition, an electrospray, a dropping, a casting, or an air-spraying.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows (A) Raman spectra of CNT-MgO formed from different loading amount of metal catalyst with the different RBM and I_{G}/I_{D} ratio, according to one embodiment of the present invention, and (B) enlarged portion of the Raman spectra;

FIG. 2 shows AFM images of a catalyst layer on the MgO substrate (A) and SWNTs formed on the MgO (B), according to one embodiment of the present invention;

FIG. 3 shows SEM images of CNTs grown on different concentrations of metallic ethanol solution supported by MgO tablet (A) amorphous carbon grown on MgO tablet by loading of about 0.01% metal catalyst (low concentration), (B) high density of SWNTs grown on the surface and (C) gap of MgO nanopowders by loading of about 0.027% metal catalyst, (D) high loading about 3% of metal catalysts catalytically growth carbon fiber and MWNTs, according to one embodiment of the present invention;

FIG. 4 shows XRD of MgO and MgO-CNTs, according to one embodiment of the present invention; and

FIG. 5 shows the CNT-MgO surface resistance as the function of catalyst metal loading amount, according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention. Additionally, some terms used in this specification are more specifically defined below.

### DEFINITIONS

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “nanoscopic-scale,” “nanoscopic,” “nanometer-scale,” “nanoscale,” the “nano-” prefix, and the like generally refers to elements or articles having widths or diameters of less than about 1 μm, preferably less than about 100 nm in some cases. In all embodiments, specified widths can be smallest width (i.e., a width as specified where, at that location, the article can have a larger width in a different dimension), or largest width (i.e., where, at that location, the article's width is no wider than as specified, but can have a length that is greater).

As used herein, “carbon nanostructures” refer to carbon fibers or carbon nanotubes that have a diameter of 1 μm or smaller which is finer than that of carbon fibers. However, there is no particularly definite boundary between carbon fibers and carbon nanotubes. By a narrow definition, the material whose carbon faces with hexagon meshes are almost parallel to the axis of the corresponding carbon tube is called a carbon nanotube, and even a variant of the carbon nanotube, around which amorphous carbon exists, is included in the carbon nanotube.

As used herein, “catalytic chemical vapor deposition method” or “CCVD” refers to a method in the art to synthesize fullerenes and carbon nanotubes by using acetylene gas, methane gas, or the like that contains carbon as a raw material, and generating carbon nanotubes in chemical decomposition reaction of the raw material gas. Among other things, the chemical vapor deposition depends on chemical reaction occurring in the thermal decomposition process of the methane gas and the like serving as the raw material, thereby enabling the manufacture of carbon nanotubes having high purity.

As used herein, the term “Raman spectroscopy” refers to an optical technique that probes the specific molecular content of a sample by collecting in-elastically scattered light. As photons propagate through a medium, they undergo both absorptive and scattering events. In absorption, the energy of the photons is completely transferred to the material, allowing either heat transfer (internal conversion) or re-emission phenomena such as fluorescence and phosphorescence to occur. Scattering, however, is normally an in-elastic process, in which the incident photons retain their energy. In Raman scattering, the photons either donate or acquire energy from the medium, on a molecular level. In contrast to fluorescence, where the energy transfers are on the order of the electronic bandgaps, the energy transfers associated with Raman scattering are on the order of the vibrational modes of the molecule. These vibrational modes are molecularly specific, giving every molecule a unique Raman spectral signature.

As used herein, the term “atomic force microscope” or “AFM” refers to a very high-resolution type of scanning probe microscope, with demonstrated resolution of fractions of a nanometer, more than 1000 times better than the optical diffraction limit. The term “microscope” in the name of “AFM” is actually a misnomer because it implies looking, while in fact the information is gathered or the action is taken by “feeling” the surface with a mechanical probe. The AFM in general has a microscale cantilever with a tip portion (probe) at its end that is used to scan the specimen surface. The cantilever is typically silicon or silicon nitride with a tip radius of curvature on the order of nanometers. When the tip is brought into proximity of a sample surface, forces between the tip and the sample lead to a deflection of the cantilever according to Hooke's law. The AFM can be utilized in a variety of applications.

As used herein, the term “scanning electron microscope” or “SEM” refers to a type of electron microscope that images the sample surface by scanning it with a high-energy beam of electrons in a raster scan pattern. The electrons interact with the atoms that make up the sample producing signals that contain information about the sample's surface topography, composition and other properties such as electrical conductivity.

As used herein, the term “X-ray diffraction” or “XRD” refers to a method of determining the arrangement of atoms within a crystal, in which a beam of X-rays strikes a crystal and diffracts into many specific directions. From the angles and intensities of these diffracted beams, a crystallographer can produce a three-dimensional picture of the density of electrons within the crystal. From this electron density, the mean positions of the atoms in the crystal can be determined, as well as their chemical bonds, their disorder and various other information.

As used herein, the terms “comprising,” “including,” “having,” “containing,” “involving,” and the like are to be understood to be open-ended, i.e., to mean including but not limited to.

### DESCRIPTION OF THE PREFERRED EMBODIMENTS

The present invention in one embodiment relates to a method for producing carbon nanotubes. The method includes the step of forming a substrate to support a catalyst used for the growth of carbon nanomaterials. The substrate according to this invention is formed from oxide powder/pellet (such as MgO, SiO₂, AI₂O₃) molding under a high pressure. For example, the substrate is formed by filling an amount of calcined MgO powders in a mold, and applying a pressure of from 2 tons to 5 tons on the mold to consolidate the calcined MgO powders so as to form the substrate. The substrate may also contain other nanomaterials such as metal nanoparticles, ceramics, polymers, etc.

The substrate can be formed in the form of molecular sieves or other oxides supports known in this art. The shape, form and dimensions of the substrate are altered according to the needs of applications.

In one embodiment, the method also includes the steps of depositing a loading amount of catalyst including iron and cobalt nanoparticles on the surfaces of the substrate, and heating the catalyst loaded on the substrate in a radio frequency reactor having a flow of a methane carbon source at a predetermined temperature so as to cause the growth of carbon nanotubes on the substrate. The loading amount of catalyst is in a range of about 0.01% to about 20% by weight. The predetermined temperature is in a range of about 500° C.-2500° C.

In another embodiment, the method includes the step of depositing a catalyst to the substrate. The catalyst comprises one or more metals selected from group VIII of the periodic table of the elements. In one embodiment, the catalyst includes a single metallic catalyst or a multi metallic catalyst. The bimetallic catalyst in one embodiment is prepared by mixing the two metallic oxides together. The bimetallic catalyst can be formed in situ through decomposition of a precursor compound such as ferric nitrate and/or cobalt nitrate. The metallic catalytic particles according to the invention are deposited on the substrate and evaporated over the substrate, such as quartz, glass, silicon and oxidized silicon surfaces under about 110° C.

Further, the method also includes the step of placing the substrate with the deposited catalyst in a reactor set in a furnace through which a flow of a carbon gas is passed into the reactor, and heating the catalyst to a predetermined temperature such that carbon nanotubes grow from the reaction of the catalyst with the carbon gas. In one embodiment, the reactor has a quartz tube, and wherein the furnace is a radio frequency furnace or oven.

In addition, the method includes the step of heating the catalyst to a predetermined temperature such that carbon nanotubes grow from the reaction of the catalyst with the carbon gas.

Broadly, the method for producing carbon nanotubes comprises the step of contacting bimetallic catalysts selected from group VIII of the peroric table of the elements with a carbon source in a radio frequency (RF) reactor heated to a temperature from about 500° C. to about 2500° C.

Carbon nanotubes are grown on the substrate by the catalytic chemical vapor deposition of hydrocarbon as the carbon source on the bimetallic catalysts system, such as with small amounts of catalytic metal, e.g., iron and cobalt of group VIII. The ratio of the two metallic catalytic particles also affects the selective production of single walled carbon nanotubes by the method of the present invention. The ratio of the metal in group VIII is preferably from about 15:1 to 1:1, and more preferably about 2:1 to 1:1. The total amount of metallic particles deposited on the support is variable widely, but is generally in an amount of from about 0.01% to about 20% of the total weight of the metallic particles.

The carbon gas include aliphatic hydrocarbons, both saturated and unsaturated gas, such as methane, ethane, propane, butane, hexane, ethylene, acetylene, CO, CO₂, methanol, ethanol, toluene, benzene and naphthalene and the mixtures of them. The carbon gas may be mixed with a diluted gas such as helium, argon, nitrogen or hydrogen.

The bimetallic catalytic particles dispersed on the support is put in a reactor, such as a quartz tube, which is set into a furnace or oven, for example, an RF furnace, and the carbon gas is passed into the reactor.

The single walled carbon nanotubes produced herein generally have a diameter of from about 0.1 nm to 10 nm. Multi-walled carbon nanotubes produced herein generally have an external diameter of from about 1 nm to about 100 nm.

The present invention also includes the deposition of polymeric materials onto/into the composites formed by carbon nanotubes growth onto the pellets of metal oxides. The present invention may also include the deposition of other materials and nanomaterials such as metal nanoparticles, metal oxide nanoparticles, metals, ceramics, biological systems, etc., onto/into the composites formed by carbon nanotubes growth onto the pellets of metal oxides. The deposition can be performed by various methods that include, but are not limited to, electrodeposition, electrospray, dropping, casting, air-spraying, etc.

The present invention is applicable to a wide spectrum of fields. Among them, the invention has been found to be particularly suited for manufacturing carbon nanotubes on a substrate. Other applications include, but are not limited to, fuel cell membranes, energy conversion, photovoltaic devices, proton exchange membranes, thermal, optical and electrical applications, etc.

These and other aspects of the present invention are further described below.

### Examples and Implementations of the Invention

Without intent to limit the scope of the invention, exemplary methods and their related results according to the embodiments of the present invention are given below. Note again that titles or subtitles may be used in the examples for convenience of a reader, which in no way should limit the scope of the invention. Moreover, certain theories are proposed and disclosed herein; however, in no way they, whether they are right or wrong, should limit the scope of the invention.

According to the exemplary embodiment of the present invention, carbon nanotubes were grown from a substrate that was formed by the high pressure molding approach. Around about 120 mg-150 mg of magnesium oxide powder was calcined under 500° C. filled into the mold specially designed for the IR. Different pressures, for example, from about 4 tons to about 10 tons, were forced into the powders. After the consolidation time, the entire load was removed at once. Finally, around 11.5 mm diameter tablets/substrates were obtained.

Different loading amounts of iron and cobalt nanoparticles, from about 0.01% to about 8% by weight, were dropped on the substrate surfaces by using micropipette. Put the substrate with catalyst into the RF oven and calcined at about 700° C. under the flow of about 200 ml/min N₂ about 1 hour and then induced the flow of about 80 ml/min of methane to reduce the catalyst to the meta state and the reaction was continued for about 30 min at about 1000° C.

Raman scattering studies of the CNTs were performed at room temperature using Horiba equipped with a charge-coupled detector, a spectrometer with a grating of about 600 lines/mm and a He—Ne laser (633 nm, 1.96 eV) as excitation sources. The laser beam intensity measured at the sample was kept at about 5 mW. The microscope focused the incident beam to a spot size less than about 0.01 mm², and the backscattered light was collected about 180° from the direction of incidence. Raman shifts were calibrated with a silicon wafer at a peak of about 521 cm⁻¹

The Raman spectra of the resulting CNT give clear evidence for the presence of SWNTs that is, strong breathing mode bands (at 100-300 cm⁻¹), characteristic of SWNT, sharp G bands (1590 cm⁻¹) characteristic of ordered carbon in sp2 configuration, and low D bans (1350 cm⁻¹), characteristic of disordered carbon in sp3 configuration.

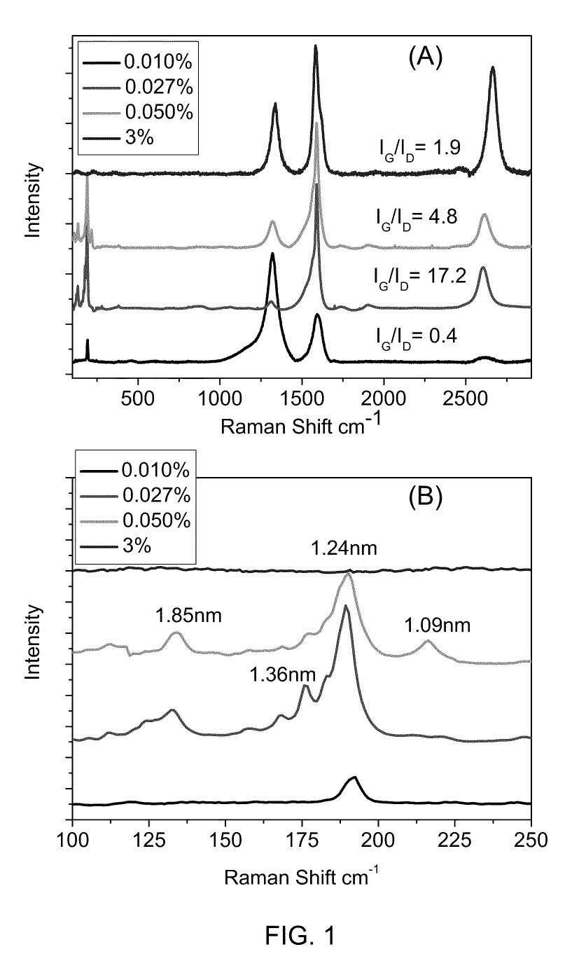

With the different amounts of metal loading, there was a range of optimum amount of metal nanoparticles found in SWNTs growing. About 0.027% of metal amount can be catalytically formed the best quality of SWNTs with the strongest Raman RBM signals, as shown in FIG. 1. With the increasing of metal, multiwall carbon nanotubes and nanofibers were formed. On the contrary, for the lower concentration of metal amount, the main product is amorphous carbon plus small portion of SWNTs. In the meantime, the ratio of I_{G}/I_{D} increased from about 0.4 to about 17.2 with the increase of the metal loading amount from about 0.01% to about 0.027%, which means SWNTs gradually became the main components on the MgO substrate and the carbon walls are close to perfect graphite state. The intensity of RBM peaks of SWNTs also reached the maximum when the metal loading amount was up to about 0.027%. If the loading amount of metals is increased, the radio of I_{G}/I_{D} became to decrease to about 4.8 and about 1.9, which means some part of multiwall nanotubes and nanofibers were formed.

Strong breathing mode bands (at about 100-300 cm⁻¹) are characteristic of SWNT. For the very low loading amount of metal, only one peak was found dominated in the 1.24 nm diameter nanotubes. But with the increasing with the metal loading amount, the carbon nanotubes diameter distribution was widened. As the result, 1.36 nm diameter nanotubes were gradually emerged as the center of 1.24 nm diameters nanotubes, and then formed the 1.85 nm diameters and the small diameter CNTs of 1.09 nm.

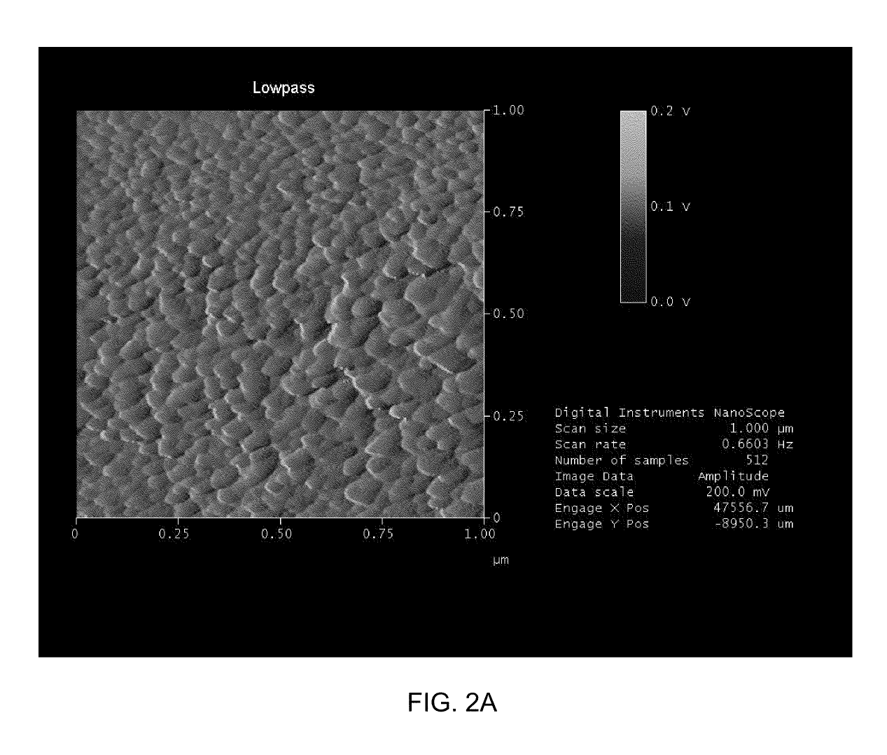

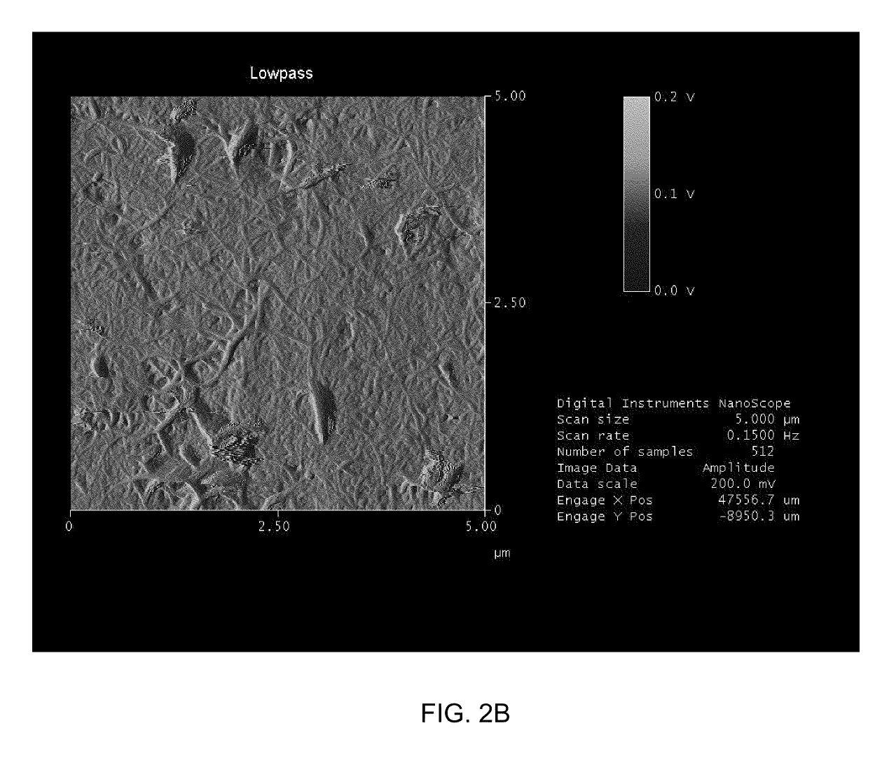

The atomic force microscope (AFM) images of the catalyst on the MgO substrate show that the catalyst nanoparticles were uniformly formed on the wafer with the small size distribution, as shown in FIG. 2A. After the reaction for about half hour, SWNTs were formed on the MgO substrate, as shown in FIG. 2B.

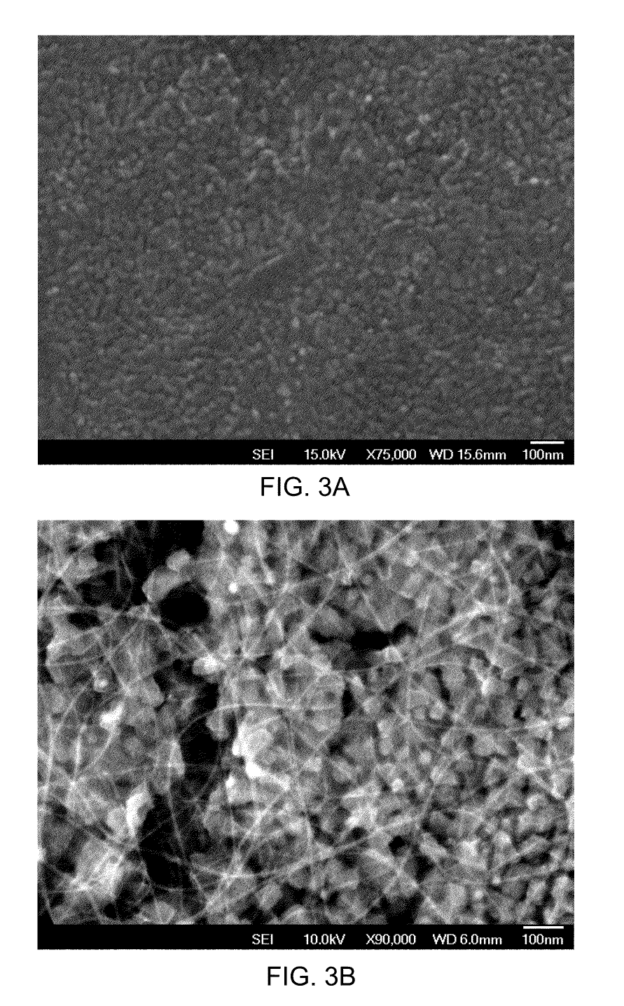

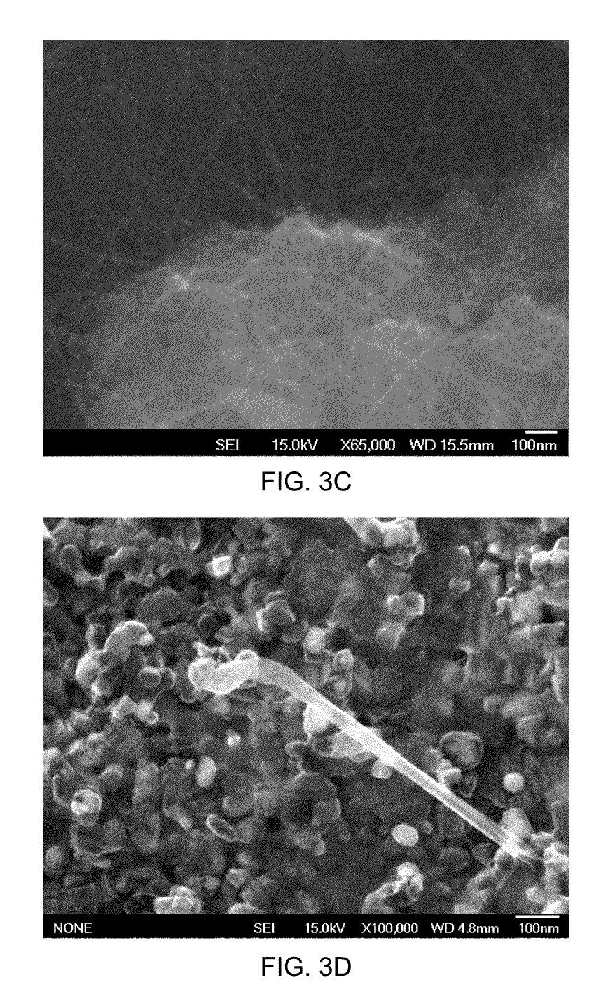

FIGS. 3A-3D show scanning electron microscope (SEM) images of CNTs grown on different concentrations of the metallic ethanol solution supported by the MgO tablet. FIG. 3A shows amorphous carbon grown on the MgO tablet by loading of about 0.01% metal catalyst (low concentration). FIG. 3B shows high density of SWNTs grown on the surface and FIG. 3C shows a gap of MgO nanopowders by loading of about 0.027% metal catalyst. FIG. 3D shows high loading about 3% of metal catalysts catalytically growth carbon fiber and MWNTs. In the SEM images shown in FIG. 3A, it is found a lot of amorphous carbon covered on the surface of MgO. It is very hard to find the carbon nanotubes because of the low density of the catalysts. When increased 2.7 times of catalysts loading amount, very pure, clean and density of SWNTs were grown everywhere on the MgO pellet surface. And the top face of the pellet changed the color from white to dark gray. From the SEM images, very density of SWNTs is shown no matter on the surface or between the gap of the nanopowders, which was shown in FIGS. 3B and 3C. If the loading amount was increased to about 0.05%, certain few walls CNTs and MWNTs started forming. Finally, when the loading amount reached about 3%, as shown in FIG. 3D, these metallic nanoparticles were aggregated together and formed the MWNTs with nanofibers.

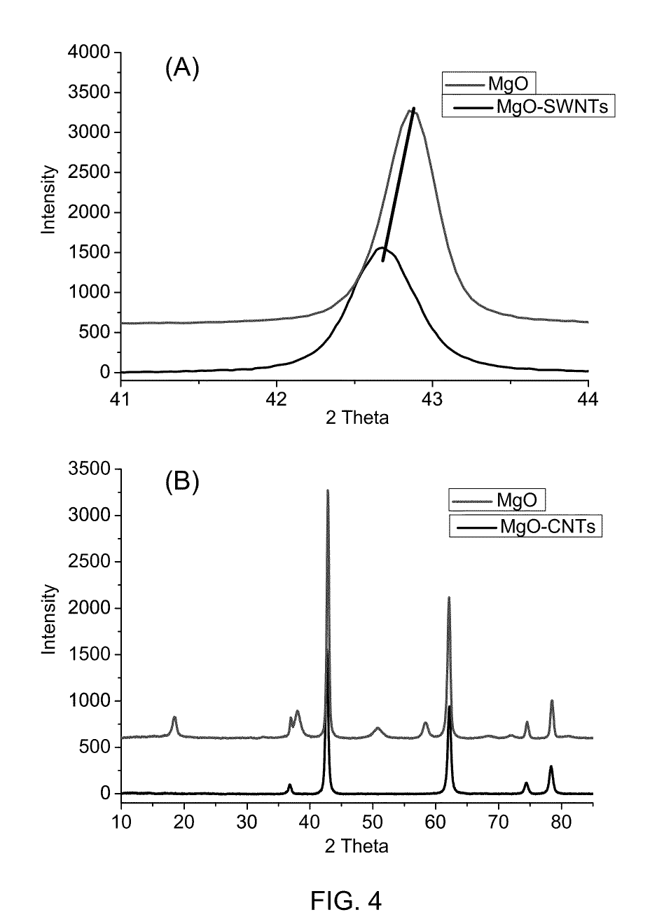

Referring to FIG. 4, X-ray diffraction (XRD) analysis was performed to elucidate how carbon species play on the MgO pellet. The peak at 42.9° was assigned to the MgO. The shift of the MgO peak shown in the FIG. 3, from 42.9° to 42.6°, also indicated the deformation of the MgO support by carbon species during CNTs growth process at about 1000° C. In addition, the peak was shifted to lower degree implied the expansion or doping of the MgO lattice by chemical reaction between the MgO and carbon source. Another possibility for the peak shift could be suggested as the formation of CxMgO solid solution by the reaction of MgO with carbon.

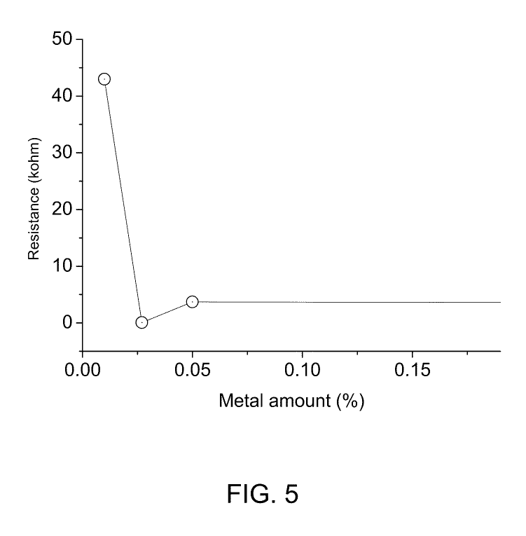

FIG. 5 shows the resistance of the MgO-CNTs as the function of metal loading amount. Interestingly, with the increasing of loading amount, the resistance of the wafer was increased. The lowest loading amount of metal on the MgO formed high conductivity carbon under the CCVD process. The MgO wafer shows the very high resistance even couldn't be tested comparing to the carbon-MgO which shows high conductivity on the contrary.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. For example, multiple probes may be utilized at the same time to practice the present invention. Accordingly, the scope of the present invention is defined by the appended claims rather than the foregoing description and the exemplary embodiments described therein.

What is claimed is:

1. A method for producing carbon nanotubes, comprising the steps of:
(a) forming a substrate;
(b) depositing a loading amount of catalyst including iron and cobalt nanoparticles on the surfaces of the substrate; and
(c) heating the catalyst deposited on the substrate in a radio frequency reactor having a flow of a methane carbon source at a predetermined temperature so as to cause the growth of carbon nanotubes on the substrate.

2. The method of claim 1, wherein the substrate is formed by:
(a1) filling an amount of calcined MgO powders in a desired mold; and
(a2) applying a predetermined pressure on the mold to consolidate the calcined MgO powders so as to form the substrate.

3. The method of claim 1, wherein the loading amount of catalyst is in a range of about 0.01% to about 20% by weight.

4. The method of claim 1, wherein the predetermined temperature is in a range of about 500° C.-2500° C.

5. Carbon nanotubes produced according to the method of claim 1.

6. A method for producing carbon nanotubes, comprising the steps of:
(a) providing a substrate;
(b) depositing a catalyst on the substrate;
(c) placing the substrate with the deposited catalyst in a reactor set in a furnace through which a flow of a carbon gas is passed into the reactor; and
(d) heating the catalyst to a predetermined temperature such that carbon nanotubes grow from the reaction of the catalyst with the carbon gas.

7. The method of claim 6, wherein the reactor comprises a quartz tube, and wherein the furnace comprises a radio frequency furnace or oven.

8. The method of claim 6, wherein the catalyst comprises one or more metals selected from group VIII of the periodic table of the elements.

9. The method of claim 8, wherein the catalyst comprises a single metallic catalyst or a multi metallic catalyst.

10. The method of claim 9, wherein the multi metallic catalyst comprises a bimetallic catalyst comprising two metals.

11. The method of claim 10, wherein the bimetallic catalyst is formed in situ through decomposition of a precursor compound including ferric nitrate and cobalt nitrate.

12. The method of claim 10, wherein the ratio of the two metals is in a range from about 15:1 to about 1:1, and preferably about 2:1 to 1:1.

13. The method of claim 6, wherein the amount of the deposited catalyst on the substrate is in a range from about 0.01% to about 20% by weight.

14. The method of claim 6, wherein the predetermined temperature is in a range of about 500° C.-2500° C.

15. The method of claim 6, wherein the carbon gas comprises aliphatic hydrocarbons, a saturated gas, and a unsaturated gas including methane, ethane, propane, butane, hexane, ethylene, acetylene, CO, CO₂, methanol, ethanol, toluene, benzene and naphthalene and the mixtures of them.

16. The method of claim 15, wherein the carbon gas is mixed with a diluted gas including as helium, argon, nitrogen or hydrogen.

17. The method of claim 6, wherein the carbon nanotubes comprise single walled carbon nanotubes having a diameter of from about 0.1 nm to 10 nm, and/or multi-walled carbon nanotubes having an external diameter of from about 1 nm to about 100 nm.

18. The method of claim 6, wherein the substrate is formed with oxide powders including MgO, SiO₂, or AI₂O.

19. Carbon nanotubes produced according to the method of claim 6.

20. A method for producing carbon nanotubes, comprises the step of:
(a) heating a metallic catalyst selected from group VIII of the periodic table of the elements with a carbon source in a radio frequency (RF) reactor to a predetermined temperature so as to grow carbon nanotubes from the reaction of metallic catalyst with the carbon source.

21. The method of claim 20, wherein the metallic catalyst is attached on a substrate.

22. The method of claim 21, wherein the carbon nanotubes are grown on the substrate by the catalytic chemical vapor deposition of hydrocarbon as the carbon source on the metallic catalyst attached on the substrate.

23. The method of claim 20, wherein the predetermined temperature is in a range of about 500° C.-2500° C.

24. Carbon nanotubes produced according to the method of claim 20.

25. A method for synthesizing a composite having the carbon nanotubes of claim 24, comprising the step of depositing one or more materials onto/into the composite.

26. The method of claim 25, wherein the one or more materials comprise at least one of polymeric materials, metal nanoparticles, metal oxide nanoparticles, metals, ceramics, and biological systems.

27. The method of claim 25, wherein the depositing is performed with an electrodeposition, an electrospray, a dropping, a casting, or an air-spraying.
